(19) United States
(12) Patent Application Publication
(10) Pub. No.: US 2026/0217539 A1
(43) Pub. Date: Jul. 30, 2026

(54) Method of making synthetic graphite from polymeric sources

(71) Applicant: Iowa State University Research Foundation, Inc., Ames, IA (US)

(72) Inventors: Cajetan Ikenna Nlebedim, Ames, IA (US); Pranav Shrotriya, Ames, IA (US); Ho-won Noh, Ames, IA (US); Anirudha Karati, Ames, IA (US); Md. Kaviul Islam, Ames, IA (US); Sourav Das, Ames, IA (US); Paul Sabyasachi, Ames, IA (US)

(21) Appl. No.: 19/419,848

(22) Filed: Dec. 15, 2025

Related U.S. Application Data
(60) Provisional application No. 63/734,796, filed on Dec. 17, 2024.

(51) Int. Cl. C01B 32/205; B29B 13/08; H01M 4/583

(52) U.S. Cl. CPC C01B 32/205; B29B 13/08; H01M 4/583; C01P 2002/72; C01P 2002/82; C01P 2002/85; C01P 2002/88; C01P 2004/03

(57) ABSTRACT

A method for producing synthetic graphite involves irradiating a carbon source material with an ultrafast pulsed laser operating at parameters effective to transform the carbon source material to synthetic graphite typically as a conductive graphitic film or layer. The carbon source material can be processed printed circuit board (PCB) material so that the non-metallic fraction thereof can be recycled.

### RELATED APPLICATION

This application claims benefits and priority of U.S. provisional application Ser. No. 63/734,796 filed Dec. 17, 2024, the entire disclosure of which is incorporated herein by reference.

### CONTRACTUAL ORIGIN OF THE INVENTION

This invention was made with government support under Grant No. DE-AC-02-07CH11358 awarded by the U.S. Department of Energy. The government has certain rights in the invention.

### FIELD OF THE INVENTION

The invention relates to a method for producing synthetic graphite and, more particularly, to production of synthetic graphitic structures by pulsed laser irradiation of a polymeric or other carbon source material including printed circuit board material.

### BACKGROUND OF THE INVENTION

Graphite, as a mineral resource, holds an extensive techno-economic value due to its application versatility. Graphite and graphitic materials possess low shear resistance (soft), excellent thermal and electrical conductivity, high stiffness and strength, thermal stability at extreme temperatures (>3600° C.), and selective chemical reactivity. These properties enable diverse applications of graphitic carbon, including electronics, mechanical components (lubricant, metallurgical, etc.), energy storage (batteries), and energy generation (nuclear)(Jara et al. 2019). Natural graphite produced through mining serves 20-40% of the global demand, and the remainder is synthesized from green coke (Surovtseva et al., 2022). However, the increasing demand and deficit of high-quality natural graphite, especially within the US(Geological Survey 2024), puts a severe impact on the supply chain. Synthetic battery-grade graphite is primarily derived from petroleum needle coke, a high-emission, energy-intensive process. Alternative feedstocks like petroleum coke, coal coke, and raw coal may become viable as technology advances (Surovtseva et al. 2022). The manufacturing process involves green coke production, calcination, and graphitization, often across separate facilities.

Green coke, derived from oil refining, is calcined into needle coke, then graphitized at temperatures above 2500° C. This yields high-purity graphite, used in various applications. While direct emissions from graphitization are underreported, indirect emissions from fossil fuels and upstream activities are documented. Emerging methods promise faster graphitization, though challenges like contamination and low yields persist. Challenges with artificial graphite formation involve extreme temperature (>2000° C.) thermal decomposition of polymers under inert atmospheric conditions. This results in 25% process efficiency and energy requirement of 4.5 kWh/kg (Dunn et al. 2015), making it exceed the natural graphite price.

With respect to the recycling of PCBs, efforts have predominantly focused on the recovery of metallic fractions, which account for approximately 28% of their total weight. Valuable metals such as copper, gold, silver, palladium, and platinum are extracted through a combination of hydrometallurgical and pyrometallurgical processes.

Also, the non-metallic fractions of PCBs, primarily composed of epoxy resin and fiberglass, have also garnered attention for their potential applications. Studies have demonstrated the utilization of these fractions as fillers in thermosetting and thermoplastic composites, modifiers for viscoelastic materials, and raw materials for concrete. Chemical recycling methods such as pyrolysis, gasification, and microwave-assisted processes have proven effective in converting non-metallic fractions into reusable chemical feedstocks. Microwave-assisted methods are particularly promising, as they efficiently recover glass fibers and resins with minimal energy consumption. The laser ablation technique has shown promise for polymer treatment for PCB, yet challenges persist due to the complex preprocessing steps required to remove metals and fiberglass. Moreover, the ablation process takes place in a deionized water medium rather than ambient conditions, limiting its practicality for broader applications. Despite these achievements, the recycling of non-metallic fractions still faces challenges, such as scalability and cost, necessitating further exploration into innovative and sustainable methods.

### SUMMARY OF THE INVENTION

Embodiments of the present invention provide a method for production of synthetic graphite wherein an electrical insulating carbon source material, such as polyimide, epoxy resin, and others, is irradiated with a pulsed laser operating at parameters including laser power density, wavelength, pulse width, and repetition rate effective to transform the carbon source material to synthetic graphite having a graphitic carbon structure with useful electrical conductance for reuse in various applications listed above including as battery electrode material.

The method can be practiced using a carbon source material that comprises a polymeric material and other carbon-containing material. Examples set forth below use polyimide polymer material or epoxy polymer material as the carbon source material for purposes of illustration and not limitation, both of which materials are used as polymer matrix material in fabrication of printed circuit boards (PCBs) as well as in other service applications.

Practice of method embodiments can produce irradiated material as a layer or film that is least 90% by volume “ideal” graphite; i.e.; comparable to commercially available synthetic graphite before or after being purified by heating in an inert atmosphere.

Practice of other method embodiments involve producing and ultrafast pulsed laser irradiating a PCB powder compact to form a surface layer or film having a graphitic carbon structure. The layer or film can be harvested as a graphitic powder for reuse, such as an electrode for various battery and other service applications. The present invention thus can provide a sustainable and innovative recycling solution for non-metallic PCB fractions, contributing to resource recovery and circular economy goals while addressing the global e-waste challenge.

These above and other advantages of the present invention will become apparent from the following detailed description taken with the following drawings.

### BRIEF DESCRIPTION OF THE DRAWINGS

FIG. 1 shows the Raman spectrum of the picosecond pulsed laser-treated polyimide material.

FIG. 2 shows the Raman spectrum of graphite powder extracted from the commercial battery [shown in FIG. 2 of (Sarkar, Shrotriya, and Nlebedim 2022)].

FIG. 3a and FIG. 3b show SEM and EDX analysis of the laser synthesized material wherein FIG. 3a provides SEM images of the laser-treated graphitic foam on a glass slide showing areas 1 and 2, which were used for elemental composition determinations. FIG. 3b shows an elemental composition map of area 1 of synthesized material (white map areas) and of area 2 of the glass slide (narrow white lap line) indicating that area 1 is mostly composed of carbon with some minor oxygen.

FIG. 4 shows a typical TGA mass loss graph for the synthesized material during purification cycles.

FIG. 5 shows the XRD patterns for as-synthesized and heat treated (thermally purified) material.

FIG. 6 shows preparation process of PCB pellet and subsequent treatment with laser on the pellet.

FIG. 7 is an FT-IR analysis of sieved PCB powder and cryo-milled PCB powder.

FIG. 8 is a TGA of the sieved powder and cryo-milled powder.

FIG. 9 is a DSC of the sieved powder and cryo-milled powder.

FIG. 10a is MS during thermal degradation of cryo-milled powder. FIG. 10b is MS during thermal degradation of sieved powder.

FIG. 11 shows variation of sheet conductivity with line energy for different laser power.

FIG. 12a shows Raman spectroscopy of laser-treated PCB pellets on lower line energy (208.3 J/m) condition. FIG. 12b shows Raman spectroscopy of laser-treated PCB pellets on higher line energy (312.5 J/m) condition.

FIGS. 13a-13d show surface morphology of the laser-treated PCB pellet using higher line energy (312.5 J/m) condition.

FIG. 14a and FIG. 14b show comparison of the surface morphology of the double laser-treated PCB pellet using higher line energy (312.5 J/m) and lower line energy (208.3 J/m) condition, respectively.

FIG. 15 shows EDS of PCB pellet on different laser treatment conditions.

FIG. 16 shows variation of sheet resistance with scan speed for different laser powers.

FIG. 17 shows TGA of laser treated PCB powders.

FIG. 18 shows DSC of the laser-treated PCB powders.

FIG. 19 shows XRD analysis of the cryo-milled raw and laser-treated PCB powder.

### DETAILED DESCRIPTION OF THE INVENTION

The present invention provides illustrative method embodiments for producing synthetic graphite wherein a carbon source material is irradiated with an ultrafast pulsed laser operating at a power density, wavelength, pulse width, and repetition rate effective to transform the irradiated carbon source material as a layer or film that is at least 90% by volume graphite.

Method embodiments can be practiced using a carbon source material that comprises a polymeric material or other carbon-containing material including, but not limited to aromatic polymers such as polyimide, poly(ether ketone), poly (ether sulfone), and others as well as epoxy resin thermosetting polymer. Example 1 set forth below used polyimide resin as the carbon source material for purposes of illustration and not limitation. Example 2 set forth below used epoxy polymer matrix of a printed circuit board (PCB) as the carbon source material for purposes of further illustration and not limitation

The following examples set forth below are offered to further describe embodiments of the invention for purposes of illustration without in any way limiting the scope of the invention. Namely, although Examples 1 and 2 set forth below employ a picosecond pulsed laser, the present invention envisions use of other pulsed lasers, such as a femtosecond pulsed laser or a nanosecond pulsed laser.

Further, the particular picosecond pulse width (duration), repetition rate, wavelength, average power density are provided in Example 1 and 2 for purposes of illustration only. The present invention envisions using other picosecond pulsed laser operating parameters. For example, in certain embodiments, the present invention employs a picosecond pulsed laser that employs a pulse width in the range of 10 fs to 110 ps, repetition rate of 5 to 100 kHz, wavelengths of 366 to 1064 nm and power density (energy fluence) of 7 J/cm² to 25 J/cm². Likewise, Example 2 refers to certain line energy values (ratio of pulse energy divided by scan speed) in the range of 0.50 to 0.625 Joule/cm for purposes of illustration and not limitation. Particular illustrative operating parameters include a pulse width of 110 ps; a repetition rate of 10 kHz, and wavelength of 1064 nm.

### Example 1

### Materials

Soluble polyimide (PI) resin (Matrimid 5218, Huntsman) was purchased from PolyK Technologies, State College PA. N-methyl-2-pyrrolidone (NMP) and other chemicals were purchased from Sigma Aldrich Inc.

### Precursor Preparation

Polyimide (PI) suspensions were prepared by mixing PI resin powder and commercial NMP (N-methyl-2-pyrrolidone) solvent in weight ratio 0.2:1 using a magnetic stirrer. The PI suspensions were deposited on the glass slides and uniformly spread to a thickness of approximately 75 μm using an instrumented blade. The liquid suspension-coated glass slides were placed in an oven at 120° C. for 24 hours to ensure complete evaporation of the NMP, resulting in a solid PI film.

### Laser Treatment and Heat Treatment

PI film-coated glass slides were irradiated in ambient air with a picosecond pulsed laser (Hylase, Inc.) operating at a wavelength of 1064 nm, pulse width (duration) of 110 ps, and repetition rate of 10 KHz using a Galvano mirror scanning stage with F-theta lens (Raylase Inc., Germany) that focuses the laser spot to about 20 μm diameter. The samples were irradiated with an average laser power density of 1900 kW/cm² and a scanning speed of 5 mm/s. Laser power density can be 1000 to 2000 kW/cm².

The laser-treated samples were subjected to multiple purification cycles involving heating each sample to a temperature of 1000° C. under a neutral (inert) gas flow (e.g., helium or argon) in an atmosphere-controlled furnace and cooling to room temperature with heating and cooling at a rate of 20° C./min.

### Laser Treated Material Characterization Methods

The treated material was characterized using Excelsior-532-150-CDRH Raman spectrometer (Spectra-Physics) with a laser operating at a wavelength of 532 nm. Additionally, FEI Quanta-FEG 250 field-emission scanning electron microscopy (SEM) and energy-dispersive X-ray spectroscopy (EDS) were used to study the morphological and chemical composition of the transformed material. The thermogravimetric analysis (TGA) was performed under Helium flow using a Netzsch STA 449 F1 Jupiter equipment at a heating and cooling rate of 20° C./min. The structural characterization of the laser-treated material was carried out using a Panalytical X-ray diffractometer (XRD) with Co-Ka radiation. The XRD scan was performed between the 26 range of 10-100° using a step width of 0.008 and a time per step width of 60 sec.

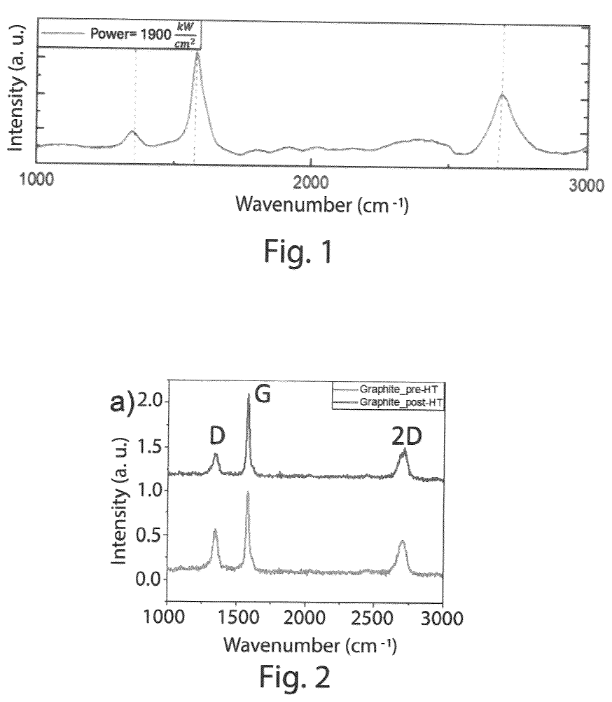

Results and Comparison with Commercial Graphite: The Raman spectrum of the laser-treated material pursuant to an embodiment of the invention is shown in FIG. 1, and the Raman spectrum of graphite powder extracted from the commercial battery is shown in FIG. 2 (Sarkar, Shrotriya, and Nlebedim 2022). The peak height ratio of the G intensity band and D intensity band in the Raman spectrum acts as a measure of structural order in the graphitic material i.e. a lower ratio indicates a higher level of defects and disorder (e.g. G band corresponds to the vibrational mode of sp²-hybridized carbon atoms arranged in hexagonal lattice structures, while the D band represents structural defects or disruptions within these layers). The I_{G}/I_{D} ratio is higher in the synthesized graphitic material (FIG. 1) compared to graphite from commercial battery cells (FIG. 2). This indicates that the synthesized materials have fewer defects and more structural order than the graphite material extracted from the commercial battery.

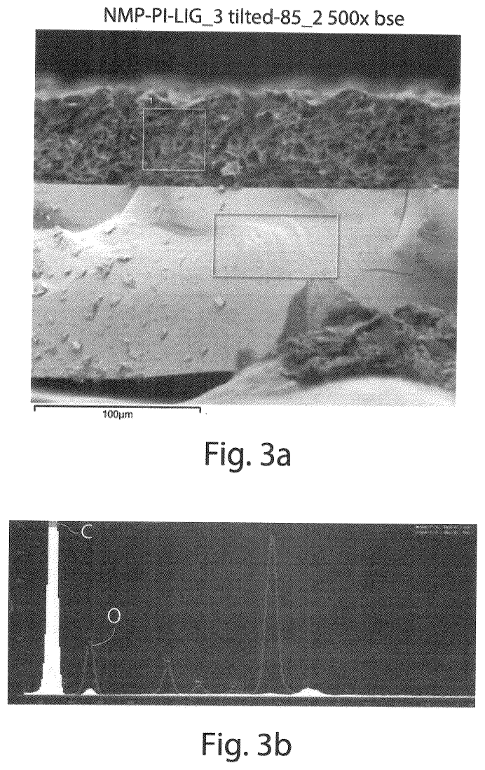

The SEM and EDS analysis, FIGS. 3a, 3b indicates that synthesized material was substantially comprised of carbon with minor content of oxygen. For example, elemental composition map (FIGS. 3a, 3b) of the area 1 on synthesized material and area 2 of glass slide showed that area 1 is mostly comprised of carbon with some minor oxygen.

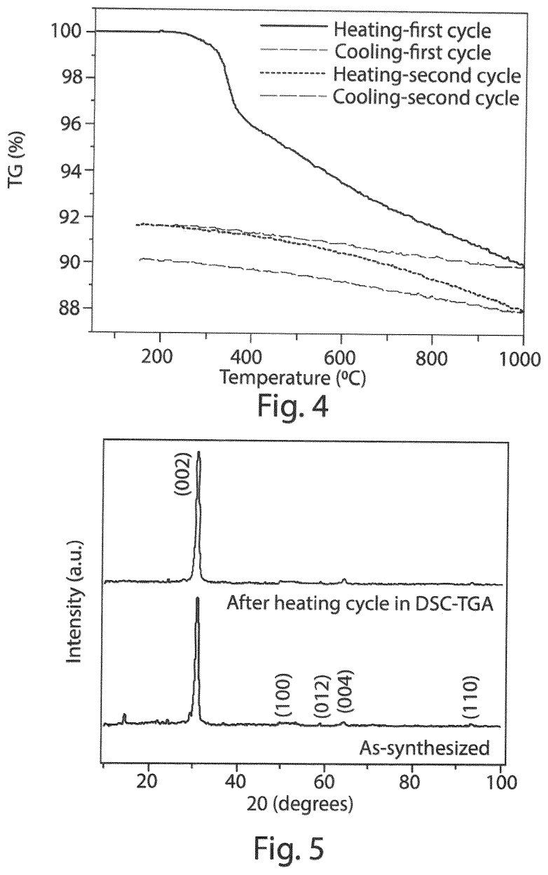

The TGA analysis of the synthesized material demonstrated a loss of mass due to the removal of untransformed polymeric material of about 10% in the purification cycle and a loss of about 3% in the subsequent cycle. A typical TGA mass loss graph for the synthesized material during the multiple purification cycles is shown in FIG. 4. The XRD patterns for synthesized and heat-treated material are shown in FIG. 5. The mass loss contributed to an increase in the purity of the sample, as confirmed by the XRD analysis of the as-synthesized material compared to that obtained after two heating cycles. The peaks matched with that of the 2H phase of graphite (PDF: 96-120-0018) (Ubbelohde, Parry, and Nixon 1965 reference listed below; Nixon, Parry, and Ubbelohde 1966 reference listed below). The peaks corresponding to the impurity phase are marked as *. The results indicate that laser-transformed materials comprised 95% graphitic phases.

The XRD spectrum was used to compute the lattice constants and degree of graphitization of the as-synthesized material (Barnakov et al. 2015 reference listed below). The lattice constants of the synthesized materials were:
a: 2.462 Å
c: 6.726 Å
d (002): 3.365 Å
and these constants correspond to a degree of graphitization of about 90% by volume in the as-synthesized material.

The laser treatment described above resulted in formation of synthetic graphite material that was verified using Raman, EDX and XRD characterization. The degree of graphitization of the synthesized material was at least 90% by volume, rendering the synthesized material suitable for graphitic material used for production of batteries such as cathode material for lithium-ion and other batteries as well as other applications including, but not limited to, capacitors, fuel cells, fire retardant, electrochemical electrodes, mechanical components (lubricant, metallurgical, etc.), and nuclear reactors.

### Example 2

Another embodiment of the present invention involves laser-induced carbonization as a novel approach for recycling non-metallic components of PCBs (printed circuit boards), specifically the epoxy polymer matrix after removal of certain recoverable metallic components from the PCB if it is being recycled after disposal

This Example employs an ultrashort picosecond pulsed laser scribing on a pellet produced from processed spent or scrap PCB material to facilitate the transformation of epoxy into graphitic carbon. This Example investigates parameters of laser treatment on PCB pellets with the goal being to optimize the carbonization process. Post-treatment analyses, including morphological and structural characterization, were performed to elucidate the conversion pathways and evaluate the potential of this method embodiment for PCB recycling and provide a sustainable alternative for managing non-metallic fractions of e-waste, with promising benefits of achieving a circular economy.

### Experimental Methods

The double-sided PCB board, utilized as a precursor material, was purchased from an Amazon store (ELEGOO model number EL-CP-021). The PCB board is comprised of FR-4 fiberglass cloth impregnated with epoxy polymer resin and an inner copper sheet or layer. As mentioned above, if a previously used PCB is involved, certain metallic fractions such as copper, gold, palladium, etc. previously deposited on the PCB as part of the electrical circuitry would be removed by magnetic and electrostatic methods of separation.

### Sample Preparation

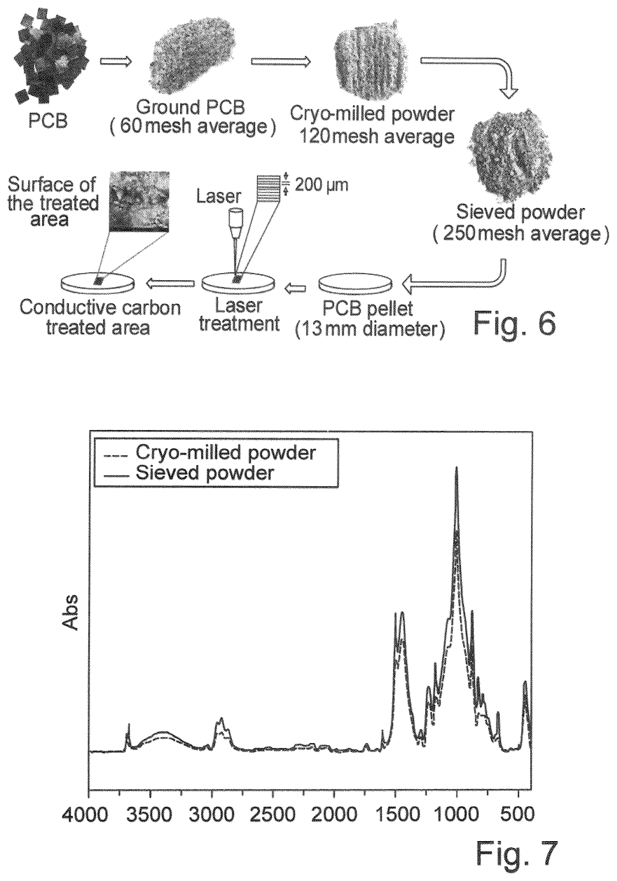

The PCB was initially crushed using an electric grinder. The resulting material, with an average size of 60 mesh, was further refined into a fine powder through cryogenic milling at liquid nitrogen temperature (77 K) for 10 minutes, performed with a Retsch CryoMill. Subsequently, the cryo-milled powder, averaging 120 mesh in size, was sieved using a 250-mesh sieve. The sieved powder was then compacted at ambient or room temperature into disc-shaped monolithic pellet (powder compact) that has a diameter of 13 mm and thickness of 1-1.25 mm using a Carver laboratory press, applying a load of up to five tons, FIG. 6.

### Laser Treatment and Characterization

The PCB pellets were synthesized, as shown in FIG. 6, and then exposed to irradiation using a picosecond pulsed laser system (Hylase, Inc.). The laser was set to pulse at 10 kHz with a pulse duration of 110 ps and a wavelength of 1064 nm. An F-theta lens (made by Raylase Inc., Germany) and a Galvano mirror scanning stage were used in this system to allow for accurate laser beam focusing to a spot size of around 20 μm on the pellet surface. The laser irradiation was controlled to form a thin layer or sheet (around 40-70 μm in thickness) of transformed graphitized material on the surface of the pellet body. A comprehensive parametric study was conducted to optimize the conversion efficiency of the pellets into carbon allotropes. This analysis systematically varied key parameters, including laser scanning speed, pulse power, and the spacing between consecutive laser lines for the particular picosecond pulsed laser described above.

X-ray fluorescence (XRF) spectroscopy was used to analyze the chemical composition of PCB materials at different phases of processing, including raw material (received), un-sieved, sieved, and laser-treated (removed from the pellet surface after the laser processing). The investigations were carried out using the Bruker M4 Tornado Micro-XRF spectrometer, which operated on a Rhodium (Rh) target at 50 kV and 300 μA and had a spot size of 25 μm.

The Jandel RM2 four-point instrument was employed to measure the sheet resistance of the laser-modified material. The XploRA Plus Raman confocal microscope (HORIBA Scientific, Edison, NJ) with a 532 nm solid-state diode laser running at 1.25 mW of power was used to perform the Raman spectral analysis. An Olympus objective lens with a numerical aperture of 0.9 and a magnification of 100× was used to acquire the spectral data in the epi-direction. Measurements were conducted using a 100 μm confocal pinhole, a 300 μm monochromator slit, and a 1200 gr/mm diffraction grating. Each spectral acquisition consisted of three accumulations averaged over 120 seconds, and data were recorded from three separate sample locations. The Raman spectra were processed and analyzed using Igor Pro (version 6.37, WaveMetrics, Inc., Lake Oswego, OR), where spectral peaks were fitted using a Lorentzian function to determine the peak positions and full-width-at-half-maximum values.

Furthermore, FEI Quanta-FEG 250 field-emission scanning electron microscopy (SEM) and energy-dispersive X-ray spectroscopy (EDS) were employed to analyze the morphological and chemical composition of the transformed material. The TGA/DSC-MS/IR analysis of the PCB (un-sieved and sieved) were conducted under argon flow utilizing a Netzsch STA 449 F1 Jupiter (TGA/DSC-MS) apparatus and Bruker Tensor 37 (FT-IR) at a heating and cooling rate of 20° C./min to examine the thermal degradation and functional bonds and evolved gas peak during the thermal degradation of the PCB in an inert environment. (MS being mass spectrometry and FT-IR being Fourier Transform Infrared emission spectroscopy).

Results: The XRF analysis is depicted in Table. 1 demonstrated substantial changes in the elemental composition of PCBs subjected to different treatments, with significant trends observed for Cu, Ca, Fe, and Ti. The analysis shows only the weight portion of the materials detected. Copper (Cu), which accounted for 35.7 wt. % in the PCB samples.

The fraction of Cu increased markedly to 58.2 wt. % following cryo-milling that can be attributed to the fragmentation of the matrix and the subsequent exposure and concentration of Cu-rich regions. However, Cu content dropped significantly in the sieved powder (7.1 wt. %) and laser-treated samples (5.6 wt. %), likely due to the size-based separation during sieving and the volatilization or oxidation of Cu under thermal processing conditions. In contrast, calcium (Ca) showed a pronounced increase, reaching 60.4 wt. % in sieved samples and 55.5 wt. % in laser-treated samples. This behavior is attributed to the isolation of Ca-rich compounds during the sieving process, where non-metallic elements became more concentrated in specific fractions, coupled with the relative enrichment of Ca caused by the volatilization of elements such as Cu. Iron (Fe) and titanium (Ti), known for their thermal stability, exhibited increasing concentrations post-processing. Fe percentage. Fe was particularly enriched in the laser-treated samples, reflecting its resistance to thermal volatilization. At the same time, Ti (titanium) displayed a similar trend due to its segregation into specific fractions during sieving and subsequent treatments.

TABLE 1
XRF analysis of the PCB samples in different processes (wt. %)

| | literature | PCB as | cryo-milled | sieved PCB | laser-treated |
|---|---|---|---|---|---|
| Element | Study | received | PCB powder | powder | (PCB pellet) |
| Si | 0.2-2.7 | 0 | 0.3 | 0.6 | 0 |
| Br | 0.01-4 | 0 | 0.02 | 0.03 | 0 |
| Ti | 4-6 | 6.5 | 1.9 | 7.4 | 6.5 |
| Cu | 10-41.7 | 35.7 | 58.2 | 7.1 | 5.6 |
| Sn | 1-5.3 | 26.9 | 9.4 | 0 | 0.06 |
| Pb | 0.01-6.3 | 20.8 | 7.5 | 3.9 | 8.4 |
| Ni | 0.26-5.4 | 0 | 0.2 | 0.9 | 1.4 |
| Al | 0.26-4.8 | 0 | 0.1 | 0.02 | 0 |
| Ga | — | 0 | 0 | 0.1 | 0 |
| Mg | 0.6 | 0 | 1.2 | 3.5 | 0 |
| Fe | 0.08-44.7 | 0.4 | 2.1 | 14.2 | 17.5 |
| Ca | 3.9 | 2.9 | 18.8 | 60.4 | 55.5 |
| Cr | 0.2 | 0 | 0.2 | 1.5 | 1.7 |
| Ce | <0.01 | 6.7 | 0 | 0 | 3.4 |

The FTIR spectra of cryo-milled and sieved PCB powders shown in FIG. 7 exhibit distinctive functional groups corresponding to the organic and polymeric constituents of the material. The broad peak at about 3400 cm⁻¹ corresponds to O—H stretching, indicative of free hydroxyl groups or adsorbed moisture, and is more pronounced in the sieved powder compared to the cryo-milled powder because sieving, performed after cryo-milling, results in further reduction of particle size and separation of finer particles. This process increases the surface area exposed to the environment, allowing for more significant adsorption of moisture and exposure of free hydroxyl groups. In contrast, the cryo-milled powder, which undergoes only initial size reduction at low temperatures, retains larger particles with relatively lower surface reactivity, leading to a less intense O—H stretching peak. Weak bands around 2900 cm⁻¹ correspond to C—H stretching, associated with aliphatic hydrocarbons from polymeric resins.

The C═C stretching vibration (~1600 cm⁻¹), characteristic of aromatic rings, appears in both cryo-milled and sieved powders with slightly higher intensity in the sieved powder. Nevertheless, the variation is insignificant, suggesting that the aromatic structures are largely unaltered by the cryo-milling and sieving processes and remain stable. This suggests that the epoxy or phenolic backbone in the PCB materials is minimally altered. The prominent absorption band at 1000-1100 cm⁻¹, attributed to C—O or Si—O stretching, is significantly stronger in the sieved powder, reflecting the fragmentation of epoxy-based materials. Peaks around 600-700 cm⁻¹ confirm C—H out-of-plane bending, indicative of aromatic rings.

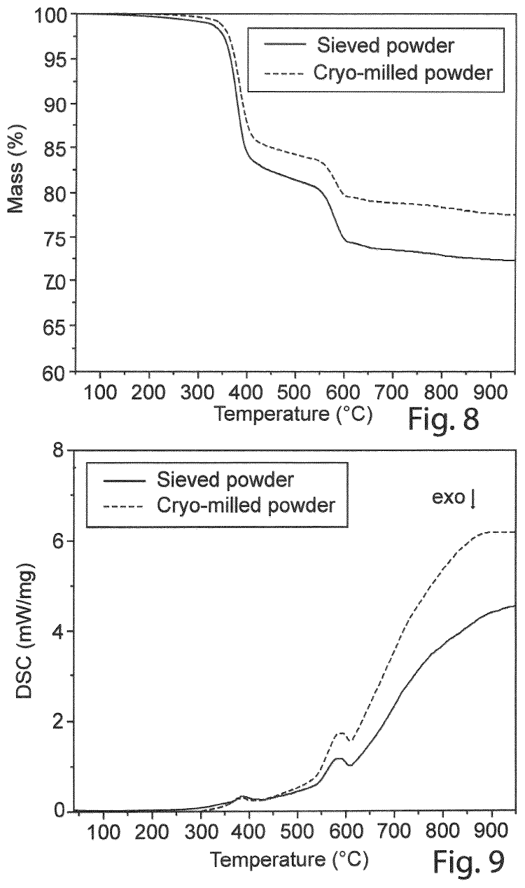

The thermal stability and decomposition behavior of sieved and cryo-milled PCB particles as a function of temperature are illuminated by the TGA results (FIG. 8). Both of these samples demonstrate noticeable weight loss in the range of 300-500° C., which suggests the thermal degradation of organic and polymeric materials, including epoxy resins commonly found in PCBs. The sieved powder exhibits a higher mass loss, resulting in a residual mass of 72.21% at 900° C., in contrast to the 77.52% observed for the cryo-milled powder. The increased residue in the cryo-milled powder indicates a higher proportion of thermally stable materials, likely resulting from less fragmentation and limited exposure of non-metallic components during the cryo-milling process. The sieved powder, on the other hand, likely promotes greater degradation due to the exposure of a larger surface area, which accelerates thermal decomposition. The endothermic and exothermic transitions that correspond to the decomposition of PCB granules are demonstrated by FIG. 9. Both the sieved and cryo-milled powders exhibit significant endothermic peaks at 410-550° C., attributed to the decomposition of epoxy resins and other organic materials. Both samples exhibit notable exothermic responses around the 570-630° C. region, as indicated by the downward trend in heat flow. These exothermic events are primarily attributed to the oxidative degradation of residual organic compounds and possibly the oxidation of exposed metal components within the PCB matrix. The cryo-milled powder, which underwent sieving prior to cryo-milling, displays a more pronounced and sharper exothermic peak compared to the solely sieved sample. This enhancement in thermal reactivity can be attributed to the mechanical fracturing and increased surface area induced by cryo-milling, which disrupts the polymeric and inorganic matrix and exposes more reactive sites. As a result, oxygen penetration and reaction rates are elevated, leading to intensified exothermic activity. In contrast, the sieved powder exhibits a broader and less intense exothermic transition, indicating a slower and more gradual oxidation process. This behavior suggests that without the mechanical refinement provided by cryo-milling, the material retains a more compact structure with lower surface reactivity.

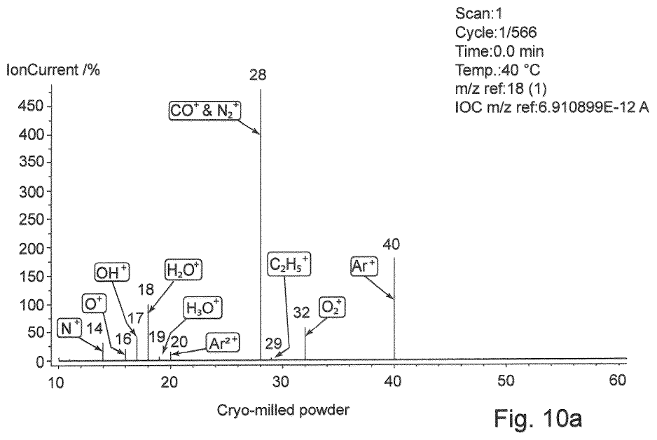

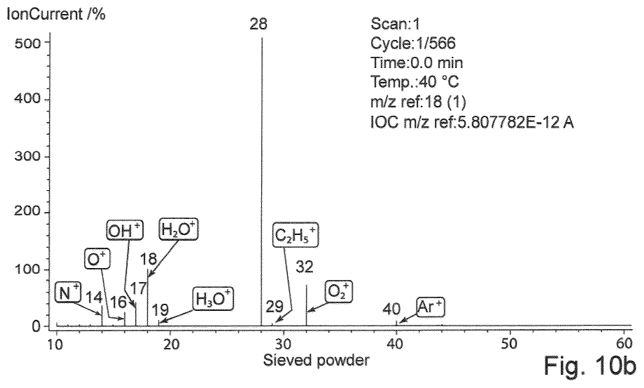

The mass spectrometry data for cryo-milled powder (FIG. 10a) and sieved powder (FIG. 10b) illustrate the volatile species emitted from PCB particles. Both samples display comparable prominent peaks, comprising N⁺ (m/z=14), O⁺ (m/z=16), OH⁺ (m/z=17), H₂O⁺ (m/z=18), and CO⁺/N₂⁺ (m/z=28), signifying the existence of nitrogen- and oxygen-containing chemicals presumably derived from organic residues and polymeric substances in the PCBs. The CO⁺/N₂⁺ (m/z=28) peak predominates in both spectra, exhibiting a significantly elevated ion current in the sieved powder, indicating that sieving, conducted post-cryo-milling, enhances gas-phase release leading to increased surface area and fragmentation.

The H₃O⁺ (m/z=19) and C₂H₅⁺ (m/z=29) peaks are less intense in the cryo-milled powder but increase in the sieved sample. This trend highlights the role of sieving in further reducing particle size, which promotes the emission of smaller volatile organic fragments. In contrast, cryo-milling at low temperatures preserves relatively larger particles, limiting the release of these species. The O₂⁺ (m/z=32) peak in both spectra suggests minor oxidation during sample preparation or ionization. The Ar⁺ (m/z=40) peak observed in both spectra corresponds to argon, which was used as the carrier gas in the experiments.

Thermal degradation of PCBs produces HBr and Brominated Phenols from brominated flame retardants. Tetrabromobisphenol A (TBBPA) at temperatures between 270° C. and 370° C. produces significant amounts of brominated compounds, particularly at m/z 78-82 (HBr: major compound of TBBPA). At high temperate like 1000° C., HBr is evolved as gas. Typically, PCBs contain around 2-8% bromine compounds.

In this experiment, however, the sieved PCB powder samples showed only 0.03% bromine, likely due to using non-soldered PCBs. Additionally, no peaks were detected in the 60-100 m/z region during mass spectrometry analysis, indicating that TBBPA was absent in both the cryo-milled and sieved PCB samples.

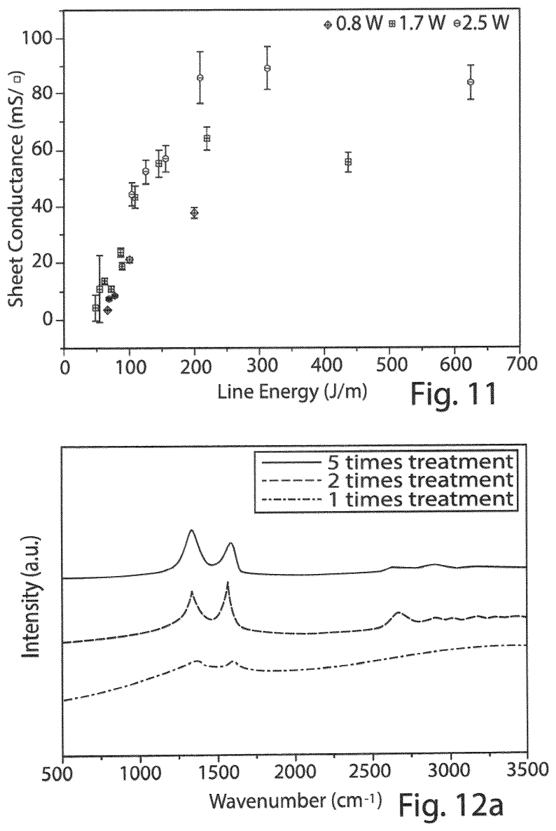

FIG. 11 illustrates the effect of varying line energy and laser power on the sheet conductance of processed PCB pellet bodies. Throughout the experiments, a uniform line spacing of 0.2 mm between adjacent laser scribing lines was maintained to ensure consistent energy delivery. At a reduced power setting of 0.8 W and lower line energy, the PCB samples exhibited a minimum sheet conductance of approximately 3 mS/square, wherein sheet conductance is expressed as milisiemens (S) per square as is known. The thin film or layer thickness is typically in the range of 0.02 to 0.05 mm on the laser-treated pellet. This low conductivity is attributed to insufficient energy absorption during laser processing, resulting in incomplete thermal transformation of the material.

As the line energy increased under the same reduced power of 0.8 W, a gradual improvement in sheet conductance was observed, reaching up to 37 mS/square at 66.7 J/m. The increase in conductivity with increasing laser power highlights the necessity for adequate laser-material interaction to facilitate effective carbonization. Since laser scanning velocity and line energy are inversely related, a decrease in scanning speed (thus higherline energy) increased the interaction time, consequently increasing the extent of carbonization and consequently, conductance. However, decreasing the scanning speed below a threshold (corresponding to line energy above 200 J/m) results in excessive energy input into the material and leads to localized charring of the material, disrupting the structural integrity of the graphite material formed due to carbonization. Hence, laser power and line energy have to be carefully selected to achieve a high efficiency of graphitization but not induce localized charring that disrupts the electrical conduction. By simultaneously varying both the laser power and the line energy, maximum sheet conductance of 89 mS/square was achieved at a laser power of 2.5 W and a line energy of 312.5 J/m. Reducing the line energy to 208.3 J/m, resulted in the sheet conductance of 85 mS/square, indicating graphitized material with high electrical conductivity could synthesized over a range of laser power and line energy processing parameters. The notable enhancement of approximately two and half times (from 37 mS/square to 85-87 mS/square) sheet conductance was achieved due to efficient graphitization during each pulse of laser irradiation and formation of improved conductive percolation pathways with the graphitized materials formed during irradiation with prior laser pulses.

However, beyond the optimal condition, a further increase in line energy adversely affected the material, leading to a significant reduction in sheet conductance. This behavior is ascribed to partial or incomplete carbonization due to localized charring induced disruption in thermal diffusion during rapid laser scanning. Additionally, double laser treatments yielded sheet conductance values of approximately 68 mS/square for higher line energy and 50 mS/square for lower line energy, respectively. Nevertheless, multiple treatments (more than 2) introduced mechanical stresses within the laser-ablated paths, as evident from visible cracking along the scribing lines, likely resulting from thermal stress accumulation during prolonged laser exposure. To date, there have been no reports on the laser-induced carbonization of printed circuit boards or the resulting sheet resistance of such samples.

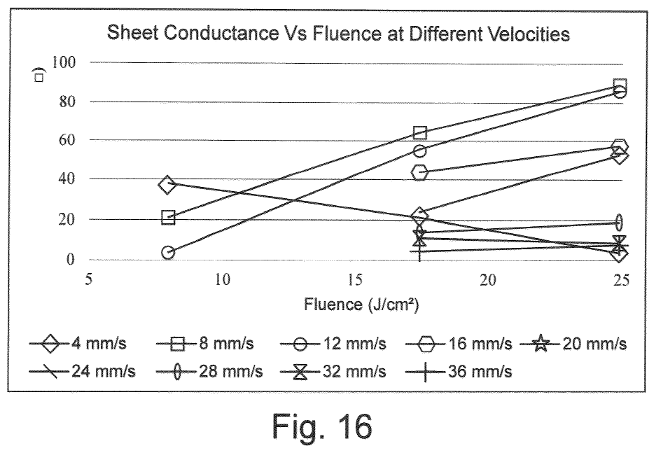

Supporting these observations, FIG. 16 presents the relationship between sheet conductance and average laser fluence across different scanning velocities. The results show that higher laser fluence correlates with greater sheet conductance, particularly at moderate velocities where thermal energy is efficiently absorbed without causing significant material damage. However, at very high fluence levels or under repeated laser treatments, thermal degradation and crack formation become more prominent, in line with the mechanical deterioration.

Also the variations of sheet resistance (ohm/square) versus scan speed (mm/s) for different laser powers of 0.8 W, 1.7 W, and 2.5 W confirm that increasing the scanning speed, thereby reducing the energy absorbed per unit area, results in higher sheet resistance. At lower speeds, the extended interaction time facilitates deeper carbonization, consistent with the improved conductance observed in FIG. 11 under higher line energy conditions.

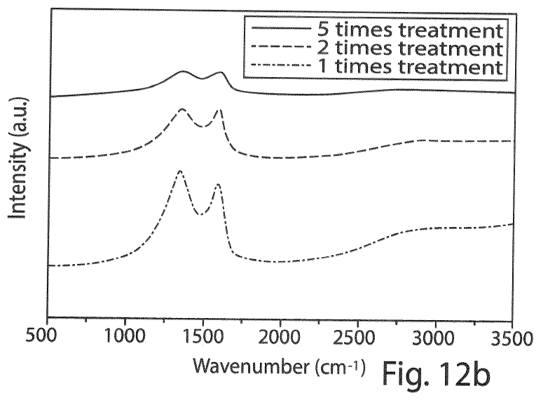

The Raman spectra of PCB pellets treated under lower line energy (208.3 J/m-FIG. 12a) and higher line energy (312.5 J/m-FIG. 12b) laser treatment conditions were compared. The varying treatment cycles reveal structural transformations in the carbon material. Under higher line energy, the spectra exhibit significant changes in the defect-related D peak and the graphitic G peak as treatment cycles increase. The G band corresponds to the vibrational mode of sp²-hybridized carbon atoms arranged in hexagonal lattice structures, while the D band represents structural defects or disruptions within these layers. The initial disordered graphitic structure is shown by the appearance of the D peak at 1327 cm⁻¹ and the G peak at 1587 cm⁻¹ for a single treatment. The D peak moves to 1346 cm⁻¹ and the G peak to 1592 cm⁻¹ following the two treatments, indicating improved graphitization with a lower amount of amorphous carbon. By the fifth treatment, the peaks move to 1353 cm⁻¹ and 1601 cm⁻¹, respectively, while the I_{D}/I_{G} ratio stabilizes at 1.16, indicating enhanced graphitic ordering without notable changes in defect density beyond the second cycle.

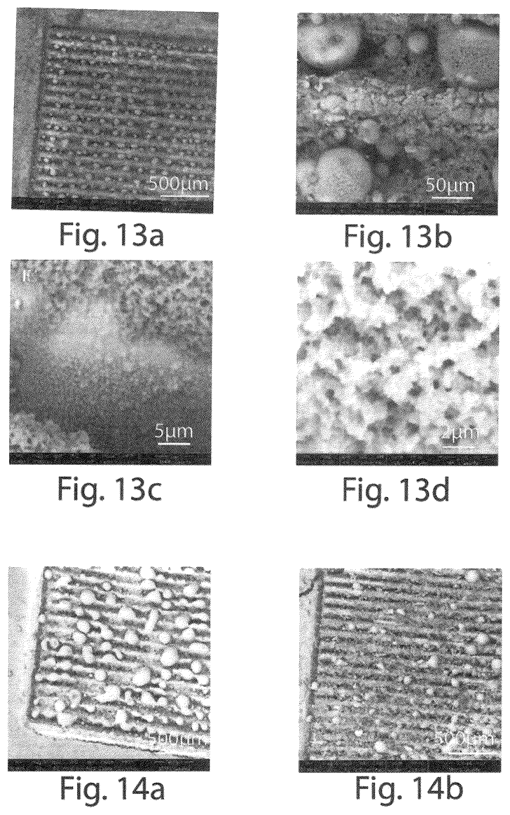

At lower line energy conditions, the Raman spectra reveal similar trends with additional structural features. Following one treatment, the D peak appears at 1346 cm⁻¹ while the G peak is noted at 1590 cm⁻¹, the material does not transform significantly due to low energy even though the material is highly conductive. After two laser treatments, the D peak changes to 1327 cm⁻¹, indicating the onset of graphene-like layer production. The 2D band demonstrates the stacking and thickness of graphitic layers, revealing information on the number of layers present. After five treatments, it is observed that the D peak shifts to 1335 cm⁻¹ and the G peak to 1587 cm-1; however, the 2D peak at 2673 cm⁻¹ remains weak and insignificant. The 120/I_{G} ratio remains low (0.2), indicating that the contribution of the 2D band is comparable to the 1l/I_{G} ratio of 1.12, which implies ongoing disorder and minimal formation of graphitic layers. The SEM images of PCB pellets subjected to single laser treatment with line energy of 312.5J/m are presented in FIG. 13a-13d. The laser created straight grooves along its path, with a consistent spacing of 200 μm between consecutive lines. These grooves highlight the transformation of the treated regions into carbon allotropes. Additionally, droplet-like features were observed in certain regions of the treated area, indicating localized material melting and re-solidification during the laser process.

Further SEM analysis of these droplets and EDS mapping revealed the presence of elements such as O, Si, Mg, Al, Ca, Pb, and Cu. These findings suggest that the droplets result from the melting of these elements due to the localized high-temperature laser effect. For double laser treatments, EDS data demonstrated an increased concentration of O and Si, potentially due to oxidation caused by repeated thermal exposure. Additionally, these melted materials appeared more evenly distributed across the treated surface after the second pass.

The SEM images for double laser treatments using both 312.5 J/m (higher line energy) and 208.3 J/m (lower line energy) are shown in FIG. 13a-13d. For the higher line energy treatment, prolonged laser interaction resulted in larger droplet sizes (FIG. 14a) compared to the droplets observed under the lower line energy condition (FIGS. 14b). This difference is attributed to the higher thermal energy input at increased line energy, leading to greater melting of the material.

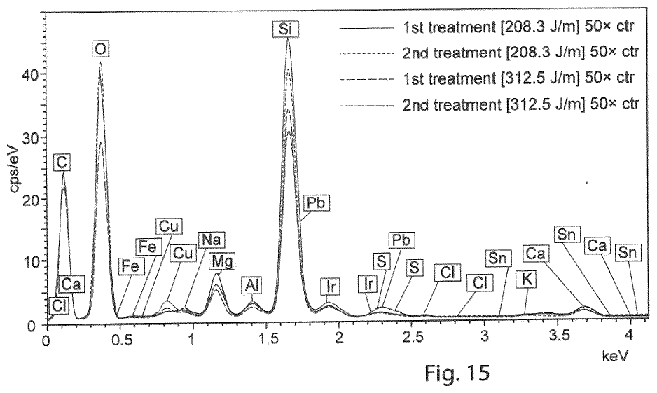

The EDS analysis of these treated pellets (FIG. 15) indicates that higher line energy leads to an elevated concentration of metallic elements such as Pb, Sn, and Cu, likely due to the melting and aggregation of these components under higher thermal loads. In contrast, the lower line energy condition showed a higher concentration of Mg, suggesting different thermal dynamics during the melting and redistribution process.

From Example 2, the ultrafast pulsed laser treatment effectively converted the epoxy matrix of PCBs into graphitic carbon, while promoting the agglomeration of metal particles into droplets on the treated surface. When rapid heating is applied via laser, the material receives sufficient energy to undergo carbonization, forming percolation pathways that enhance sheet conductance. In the case of pulsed lasers, an intense amount of energy is delivered in a very short duration, initiating rapid chemical transformations that quickly cease once the pulse ends. This intermittent energy delivery creates a dynamic heating process; the material heats up during the initial pulse and transitions into an intermediate state before the subsequent pulse strikes. As a result, the material does not fully stabilize between pulses, which leads to incremental transformations, such as the melting observed in SEM images, particularly under elevated conditions.

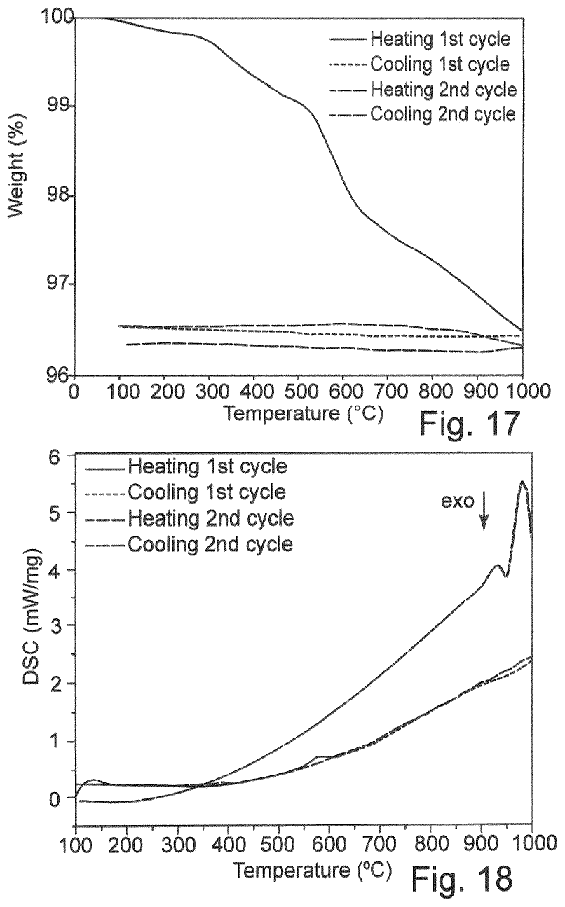

The thermogravimetric (TGA) and differential scanning calorimetry (DSC) analyses of the carbonaceous powder, obtained from laser-treated PCB pellets by mechanical abrasion of the treated surface and subsequently sieved through a 700-mesh screen, are presented in FIG. 17 and FIG. 18). These characterizations provide critical insights into the thermal stability and phase transitions of the laser-induced carbon material.

In the TGA profile (FIG. 17), the sample demonstrates remarkable thermal stability, with a minor weight loss of approximately 4% over the full heating range up to 1000° C. This slight reduction in mass is primarily attributed to the release of residual volatile species and potential moisture adsorption on the high-surface-area carbon powder. Notably, no significant decomposition or oxidation events were observed, indicating a high degree of carbonization and inertness of the laser-treated material under the applied heating conditions. Furthermore, during the second heating cycle, the weight remained nearly constant, further confirming the thermal robustness of the produced carbon phase. The DSC analysis (FIG. 18) reveals the distinct exothermic features observed during the cooling phases of both thermal cycles, occurring in the range of about 920-980C °. These consistent downward peaks, denoted by the arrow in the figure, point to potential structural reordering or crystallization-like behavior, likely associated with rearrangements in graphitic domains or subtle phase adjustments in metal-oxide residues. The close overlap of the two cooling curves suggests thermal equilibrium and stability of the carbon phase upon repeated thermal cycling. In contrast, the heating cycles exhibit a monotonic and featureless increase in heat flow, indicating a lack of phase transitions during heating phase.

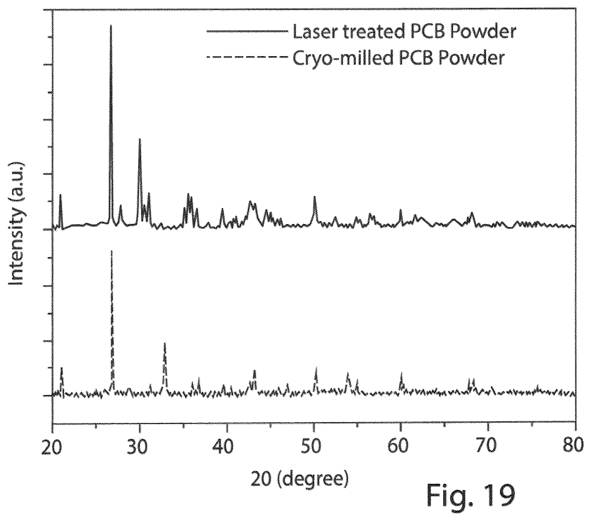

The X-ray diffraction patterns of the raw and laser-treated printed circuit board (PCB) powders exhibit clear distinctions in phase composition and structural ordering that is shown in FIG. 19. The raw PCB sample displays a largely amorphous profile, with a broad diffuse hump centered between 20° and 25° 2θ, attributable to the disordered epoxy resin matrix. A weak diffraction signal around 26.6° 2θ is consistent with the presence of amorphous or poorly crystalline SiO₂, likely originating from fiberglass reinforcement used in PCB substrates. No significant peaks corresponding to carbon allotropes or metallic copper are detected in the raw sample, indicating the predominantly non-crystalline nature of the carbon and the dilution or absence of metallic copper in the fine powder fraction after cryogenic milling.

In contrast, the laser-treated PCB powder (removed from the pellet) reveals several sharp diffraction peaks, indicating substantial phase transformation due to laser-induced thermal effects. A prominent peak at 26.4° 2θ corresponds to the (002) reflection of graphitic carbon (PDF:99-800-0391; PDF: 99-800-1340), confirming the conversion of amorphous epoxy into crystalline or turbostratic graphite-like structures. This structural ordering is consistent the formation of laser-induced graphene (LIG) from polymeric substrates under ultrafast laser exposure.

Additionally, the emergence of new peaks at 36.4°, 42.3°, and 61.3° 2θ corresponds to Cu₂O (cuprite) (PDF: 99-800-1110) and CuO (tenorite) (PDF: 99-800-0494), indicating oxidation of copper traces within the PCB matrix during laser processing in ambient air. The absence of metallic Cu° (typically at about 43.3° 2θ) suggests that most of the copper underwent partial or complete oxidation. These transformations align with reported thermal behaviors of copper under oxidative environments during laser irradiation.

Notably, sharper peaks near 20.8° and 26.6° 2θ are observed in the laser-treated sample compared to the raw PCB. These are attributed to crystalline SiO₂ polymorphs, such as α-quartz, and possibly stishovite (PDF: 99-800-0231), a high-pressure tetragonal form of silica. The formation of stishovite may be facilitated by rapid localized heating and pressure effects from pulsed laser irradiation, which have been previously associated with transient shock conditions.

Single-pass laser treatments facilitated partial graphitization and reduced sheet resistance due to the creation of enhanced electrical conduction percolation pathways. Double treatments further improved graphitization and uniform droplet formation, as evidenced by the presence of 2D peaks in Raman spectra and improved structural organization. However, despite the improved graphitization observed with double treatments, the percolation pathways were reduced due to the melting of metallic particles. Additional laser treatments introduced thermal stresses, resulting in mechanical cracks in the treated zones, which negatively impacted both the structural integrity and conductivity of the material. These findings underscore the importance of optimizing laser parameters, including power, speed, and the number of treatment cycles, to achieve effective conversion to graphitic carbon while minimizing mechanical damage. Balancing these parameters is essential for attaining both material stability and optimal electrical conductivity.

This Example 2 demonstrates the feasibility of employing ultrashort pulse picosecond laser treatment to convert the epoxy matrix of PCB materials into conductive graphitic structures, offering a novel and sustainable approach to recycling non-metallic fractions of PCBs. Comprehensive characterization before and after laser processing confirmed significant morphological and structural transformations, with Raman spectroscopy and SEM analyses highlighting successful graphitization under specific laser parameters. Optimal results were achieved under higher line energy (312.5 J/m), yielding a sheet conductance as high as 89 mS/square. Single laser treatments at higher line energy showed higher sheet conductance but higher defect density, whereas double treatments slightly improved graphitization while maintaining moderate defects. In contrast, lower line energy (208.3 J/m) required double laser treatments to achieve optimal graphitization, evidenced by a relatively low I_{D}/I_{G} ratio of 0.67, envisioning a ratio of 0.60 or lower in certain method embodiments, and the formation of few-layer graphene-like structures. Moreover, lower line energy resulted in reduced droplet formation due to limited metal particle melting. This study underscores the potential of laser-induced carbonization as a sustainable recycling solution for non-metallic PCB fractions, advancing resource recovery and contributing to circular economy goals while addressing the environmental impacts of e-waste.

### Example 3

The following example involves use of laser-treated polyimide (PI) produced as described in Example 1 as a battery electrode (i.e. anode of Li-ion cell) for purposes of illustration and not limitation.

### Synthetic Graphite Slurry Preparation:

Laser-converted anode powder (LCP) from polyimide (from Example 1) was stored overnight at 90 deg C. to remove moisture from the sample. A coating slurry was prepared by mixing the anode powder and PVDF (polyvinylidene fluoride) into a solution of NMP liquid organic solvent (<1%) at a temperature of 90 deg C. Once prepared, the resulting slurry was coated onto copper foil and left in a vacuum oven overnight at 90° C. A layer of laser-treated anode powder was left on the copper foil and had a thickness of about 20-25 μm.

### Electrochemical Measurement:

The coated copper foil was cut to the diameter “d” typical for Li-ion cells (e.g. d=12 mm), and assembled in a half cell (vs Lithium Metal). A commercially purchased LiPF₆-based electrolyte and lithium metals were used to assemble the half cell. After assembly, the cells were stored for 12-18 hours and 5-formation charging cycles between 0.005V to 2V at a rate of 0.2 mA with a brief 30-minute rest period were used to form a stable SEI (solid electrolyte interface) on the anode. Capacity of the converted synthetic graphite carbon layer material was estimated using 5 charge/discharge cycles between 0.005V to 1.5V at a rate of 0.2 mA. The average measured capacity during discharge was used to estimate the specific lithium storage capacity of the converted synthetic graphite carbon layer material and was found to be 186 mAh/gm.

In comparison, the observed specific capacity for commercial graphite half cells formed using a similar procedure was found to be about 320 mAh/gm.

The results of Example 3 indicate the anodic power collected from Example 1 has a cyclable capacity with very low self-discharge rate and reversible charging capacity reaching up to 60% of its commercial counterpart.

Embodiments of the present invention described in Example 2 provide a novel approach to PCB recycling by employing ultrashort pulse picosecond laser treatment to induce carbonization of the epoxy polymer matrix into graphitic materials.

Although the present invention has been described above with respect to certain embodiments for purposes of illustration, those skilled in the art ill appreciate that the scope of the present invention is not limited to these embodiments and is set forth in the appended claims.

### REFERENCES WHICH ARE INCORPORATED HEREIN BY REFERENCE

Barnakov, Ch N, GP Khokhlova, AN Popova, SA Sozinov, and ZR Ismagilov. 2015. ‘XRD characterization of the structure of graphites and carbon materials obtained by the low-temperature graphitization of coal tar pitch’, Eurasian Chemico-Technological Journal, 17: 87-93.
Nixon, D. E., G. S. Parry, and A. R. Ubbelohde. 1966. ‘ORDER-DISORDER TRANSFORMATIONS IN GRAPHITE NITRATES’, Proceedings of the Royal Society of London Series a-Mathematical and Physical Sciences, 291: 324-+.
Sarkar, Abhishek, Pranav Shrotriya, and Ikenna C Nlebedim. 2022. ‘Electrochemical-driven green recovery of lithium, graphite and cathode from lithium-ion batteries using water’, Waste Management, 150: 320-27.
Ubbelohde, A. R., G. S. Parry, and D. Nixon. 1965. ‘ORDER-DISORDER TRANSFORMATIONS IN GRAPHITE NITRATES’, Nature, 206: 1352-+.Chung, D. D. L. 2002. “Review Graphite.” Journal of Materials Science 37:1475-89. doi: https://doi.org/10.1023/A:1014915307738.
Dunn, Jennifer B., Christine James, Linda Gaines, Kevin Gallagher, Qiang Dai, and Jarod C. Kelly. 2015. Material and Energy Flows in the Production of Cathode and Anode Materials for Lithium Ion Batteries. Argonne, IL (United States). doi: 10.2172/1224963.
Geological Survey, Us. 2024. MINERAL COMMODITY SUMMARIES 2024.
Jara, Allah D., Amha Betemariam, Girma Woldetinsae, and Jung Yong Kim. 2019. “Purification, Application and Current Market Trend of Natural Graphite: A Review.” International Journal of Mining Science and Technology 29(5):671-89. doi: 10.1016/j.ijmst.2019.04.003.
Surovtseva, Daria, Enda Crossin, Robert Pell, and Laurence Stamford. 2022. “Toward a Life Cycle Inventory for Graphite Production.” Journal of Industrial Ecology 26(3). doi: 10.1111/jiec.13234.

We claim:

1. A method for producing synthetic graphite, comprising irradiating a carbon source material with a pulsed laser operating at laser parameters effective to transform at least a portion of the carbon source material to graphitic carbon structure.

2. The method of claim 1 wherein the laser parameters include average power density, wavelength, pulse width, and repetition rate.

3. The method of claim 1 wherein the carbon source material comprises a polymeric material or other carbon containing material.

4. The method of claim 3 wherein the polymeric material is polyimide.

5. The method of claim 3 wherein the polymeric material is epoxy polymer.

6. The method of claim 5 wherein the epoxy polymer is a constituent of a printed circuit board.

7. The method of claim 1 wherein a degree of graphitization of the carbon source material is at least 90% by volume.

8. The method of claim 1 that produces the irradiated carbon source material as a layer or film that is at least 90% by volume graphite.

9. The method of claim 1 wherein the irradiated carbon source material is purified by heating to provide 95% by volume or more graphitic phases.

10. The method of claim 1 including the step of preparing a suspension of carbon source powder material and depositing the suspension onto a substrate as a layer whose surface is irradiated by the laser.

11. The method of claim 1 that produces synthetic graphitic structure having a relatively low Raman spectrometry ratio of/I_{G}, where I_{D} represents a disordered structure and I_{G} represents a crystalline graphitic structure.

12. A method of treating a printed circuit board containing epoxy polymer as a constituent, comprising a) comminuting the printed circuit board to produce particulates, b) consolidating the particulates to form a powder compact, and c) irradiating a surface of the compact with a pulsed laser operated in a manner to transform at least a portion of the compact to a conductive graphitic carbon structure.

13. The method of claim 12 wherein the ultrafast pulsed laser is a picosecond pulsed laser, a femtosecond pulsed laser or a nanosecond pulsed laser.

14. The method of claim 12 wherein the laser line energy is controlled to achieve conversion to graphitic carbon while minimizing mechanical damage.

15. The method of claim 12 that produces synthetic graphitic carbon structure having a relatively low Raman spectrometry ratio of I_{D}/I_{G}, where I_{D} represents a disordered structure and I_{G} represents a graphitic structure.

16. The method of claim 12 wherein a surface region of the compact is transformed to the graphitic carbon structure and the surface region is removed as a powder.

17. The method of claim 16 including repeating the laser irradiation of the compact after the powder is removed from the surface region.

18. Synthetic graphite produced by the method of claim 1.

19. Synthetic graphite produced by the method of claim 12.

20. A battery electrode comprising the synthetic graphite of claim 1.
